(19) United States
(12) Patent Application Publication
(10) Pub. No.: US 2025/0321685 A1
(43) Pub. Date: Oct. 16, 2025

(54) SYSTEM AND METHOD FOR EFFICIENTLY SCALING AND CONTROLLING INTEGRATED IN-MEMORY COMPUTE

(71) Applicant: Rain Neuromorphics Inc., San Francisco, CA (US)

(72) Inventors: Burak Erbagci, San Jose, CA (US); Cagla Cakir, San Francisco, CA (US); Muzaffer Kal, Redmond, WA (US); Alexander Almela Conklin, San Jose, CA (US); Tracey DellaRova, Wake Forest, NC (US)

(21) Appl. No.: 19/034,331

(22) Filed: Jan. 22, 2025

Related U.S. Application Data
(60) Provisional application No. 63/624,479, filed on Jan. 24, 2024.
(60) Provisional application No. 63/624,487, filed on Jan. 24, 2024.
(60) Provisional application No. 63/624,491, filed on Jan. 24, 2024.

(51) Int. Cl. G06F 3/06

(52) U.S. Cl. CPC G06F 3/0625; G06F 3/0659; G06F 3/0673

(57) ABSTRACT

A compute engine including an input buffer and a compute-in-memory (CIM) hardware module is described. The input buffer is coupled to the CIM hardware module and provides an input vector to the CIM hardware module. The CIM hardware module includes an array of storage cells and compute logic. The array of storage cells is configured to store weights corresponding to a matrix. The compute logic is configured to perform a vector-matrix multiplication (VMM) for the matrix and the input vector. The array of storage cells includes storage blocks. Each storage block includes rows and a particular number of columns corresponding to a portion of the matrix. The compute logic includes compute logic blocks. Each compute logic block corresponds to a storage block of the storage blocks. The compute logic block performs a portion of the VMM for the portion of the matrix.

### CROSS REFERENCE TO OTHER APPLICATIONS

This application claims priority to U.S. Provisional Patent Application No. 63/624,479 entitled SYSTEM AND METHOD FOR EFFICIENTLY SCALING INTEGRATED IN-MEMORY COMPUTE filed Jan. 24, 2024, U.S. Provisional Patent Application No. 63/624,487 entitled MODULAR ACTIVATION OF INTEGRATED IN-MEMORY COMPUTE filed Jan. 24, 2024, and U.S. Provisional Patent Application No. 63/624,491 entitled POWER MODES FOR INTEGRATED IN-MEMORY COMPUTE filed Jan. 24, 2024, all of which are incorporated herein by reference for all purposes.

### BACKGROUND OF THE INVENTION

Artificial intelligence (AI), or machine learning, utilizes learning networks loosely inspired by the brain in order to solve problems. Learning networks typically include layers of weights that weight signals (mimicking synapses) combined with activation layers that apply functions to the signals (mimicking neurons). The weight layers are typically interleaved with the activation layers. In the forward, or inference, path, an input signal (e.g. an input vector) is propagated through the learning network. In so doing, a weight layer can be considered to multiply input signals (the input vector, or “activation”, for that weight layer) by the weights (or matrix of weights) stored therein and provide corresponding output signals. For example, the weights may be analog resistances or stored digital values that are multiplied by the input current, voltage or bit signals corresponding to the input vector. The weight layer provides weighted input signals to the next activation layer, if any. Neurons in the activation layer operate on the weighted input signals by applying some activation function (e.g. ReLU or Softmax) and provide output signals corresponding to the statuses of the neurons. The output signals from the activation layer are provided as input signals (i.e. the activation) to the next weight layer, if any. This process may be repeated for the layers of the network, providing output signals that are the resultant of the inference. Learning networks are thus able to reduce complex problems to a set of weights and the applied activation functions. The structure of the network (e.g. the number of and connectivity between layers, the dimensionality of the layers, the type of activation function applied), including the value of the weights, is known as the model.

Although a learning network is capable of solving challenging problems, the computations involved in using such a network are often time consuming. For example, a learning network may use millions of parameters (e.g. weights), which are multiplied by the activations to utilize the learning network. Learning networks can leverage hardware, such as graphics processing units (GPUs) and/or AI accelerators, which perform operations usable in machine learning in parallel. Such tools can improve the speed and efficiency with which data-heavy and other tasks can be accomplished by the learning network. However, challenges still exist. For example, it may be desirable to scale the AI accelerator to larger sizes (larger numbers of parameters) and/or higher precisions without significantly reconfiguring the hardware. For many applications, such as edge devices, this is desired to be accomplished without unnecessarily increasing power consumption. Consequently, improvements are still desired.

### BRIEF DESCRIPTION OF THE DRAWINGS

Various embodiments of the invention are disclosed in the following detailed description and the accompanying drawings.

FIGS. 1A-1B depict an embodiment of a portion of a compute engine usable in an accelerator for a learning network and a compute tile with which the compute engine may be used.

FIG. 2 depicts an embodiment of a portion of a compute engine usable in an accelerator for a learning network and capable of performing local updates.

FIG. 3 depicts an embodiment of a portion of a compute-in-memory module usable in an accelerator for a learning network.

FIG. 4 depicts an embodiment of a portion of a compute-in-memory module usable in an accelerator for a learning network.

FIGS. 5A-5C depict embodiments of portions of a compute engine that may be hierarchically organized and/or scaled.

FIG. 6 depicts an embodiment of a portion of a compute-in-memory hardware module that may be hierarchically organized and/or scaled.

FIG. 7 depicts an embodiment of a portion of a compute-in-memory hardware module that may be hierarchically organized and/or scaled.

FIG. 8 depicts a portion of a compute engine for which power is controlled.

FIGS. 9A-9B depict embodiments of a portion of a compute engine having managed driving of input vectors.

FIG. 10 is a flow-chart depicting an embodiment of a method for using a compute engine that may be hierarchically organized or scaled.

FIG. 11 is a flow-chart depicting an embodiment of a method for managing power driving of input vectors for a compute engine.

FIG. 12 is a flow-chart depicting an embodiment of a method for managing power for a compute engine.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A compute engine including an input buffer and a compute-in-memory (CIM) hardware module is described. The input buffer is coupled to the CIM hardware module and provides an input vector to the CIM hardware module. The CIM hardware module includes an array of storage cells and compute logic. The array of storage cells is configured to store weights corresponding to a matrix. The compute logic is configured to perform a vector-matrix multiplication (VMM) for the matrix and the input vector. The array of storage cells includes storage blocks. Each storage block includes storage cells for rows and a particular number of columns corresponding to a portion of the matrix. The compute logic includes compute logic blocks. Each compute logic block corresponds to a storage block of the storage blocks. The combination of a compute logic block and its corresponding storage block may be considered to form a CIM module block. The compute logic block performs a portion of the VMM for the portion of the matrix. Stated differently, the CIM module block performs a portion of the VMM for a portion of the matrix.

In some embodiments, each compute logic block includes an adder tree and an accumulator. Each compute logic block may also include logic gate(s) configured to perform multiplications of a weight and an element of the input vector. Each storage block may correspond to a base precision of the plurality of weights. For example, a storage block (and thus a CIM module block) may correspond to four bits.

The compute logic blocks may include compute logic block pairs. The storage blocks may include storage block pairs. Each compute logic block pair includes a first compute logic block and a second compute logic block. Each storage block pair includes a first storage block and a second storage block. The first compute logic block corresponds to the first storage block and the second compute logic block corresponds to the second storage block. Each compute logic block pair further includes merge logic for merging a first resultant of the first compute logic block with a second resultant of the second compute logic block. Thus, CIM module block pairs may be considered to be formed by the compute logic block pair, the corresponding storage block pair, and the merge logic. In such embodiments, each CIM module block may correspond to four bits (i.e. the base precision is four bits) and wherein each eight bit weight is stored across the storage block pair.

In some embodiments, the CIM hardware module includes banks. Each bank includes at least one storage block. The CIM hardware module may further include input vector driving circuitry for a first bank and a second bank of the plurality of banks. The input vector driving circuitry is configured to drive the input vector to the second bank if the second bank stores a portion of the plurality of weights. Thus, in some embodiments, elements of the input vector are not provided to banks that do not store weights.

In some embodiments, the compute engine includes weight update circuitry for storing data to the plurality of storage cells. In such embodiments, the compute logic, the storage cells, and the weight update circuitry are configured to be selectively receive power. Thus, the compute logic, the array of storage cells, and the weight update circuitry may be individually powered on, powered off, or placed in low power mode.

A compute tile is described. The compute tile includes at least one general-purpose GP processor and compute engines. The compute engines are coupled with the GP processor(s). Each compute engine includes an input buffer and a compute-in-memory CIM hardware module. Thus, the compute tile may be considered to incorporate one or more of the compute engines described herein.

A method including providing an input vector to a CIM hardware module is described. The CIM hardware module includes an array of storage cells for storing weights corresponding to a matrix and compute logic configured to perform a VMM for the matrix and the input vector. The array of storage cells includes storage blocks. Each storage block includes a portion of the storage cells in the array and corresponds to a plurality of rows and a particular number of columns corresponding to a portion of the matrix. The compute logic includes compute logic blocks. Each compute logic block corresponds to a storage block. A compute logic block and a corresponding storage block may be considered to be a CIM module block. The method also includes performing, using the CIM hardware module, the VMM such that each compute logic block performs a portion of the VMM for the portion of the matrix.

The compute logic blocks may include compute logic block pairs. The storage blocks may include storage block pairs. Each compute logic block pair includes a first compute logic block and a second compute logic block. Each storage block pair includes a first storage block and a second storage block. The first compute logic block corresponds to the first storage block and the second compute logic block corresponds to the second storage block. Each compute logic block pair further includes merge logic for merging a first resultant of the first compute logic block with a second resultant of the second compute logic block. In such embodiments, the method may further include determining the first resultant and the second resultant and merging, using the merge logic, the first resultant and the second resultant. Thus, a final resultant for the VMM may be provided.

In some embodiments, the CIM hardware module includes banks, each of which includes storage block(s). The banks include a first bank and a second bank. In such embodiments, the method may further include selectively driving the input vector to the second bank of a first and second bank if the second bank stores a portion of the plurality of weights.

In some embodiments, the CIM hardware module further includes weight update circuitry for storing data to the plurality of storage cells. The compute logic, the plurality of storage cells, and the weight update circuitry are configured to selectively receive power. The method further includes individually powering on, powering off, or placing in low power mode the weight update circuitry the plurality of storage cells, and the compute logic.

The methods and systems are described in the context of particular features. For example, certain embodiments may highlight particular features. However, the features described herein may be combined in manners not explicitly described. Although described in the context of particular compute engines, CIM hardware modules, storage cells, and logic, other components may be used. For example, although particular embodiments utilize digital SRAM storage cells, other storage cells, including but not limited to analog storage cells (e.g. resistive storage cells) may be used. Similarly, although described in the context of weights and activations, other input vectors (or matrices) and other tensors may be used in conjunction with the methods and systems described herein.

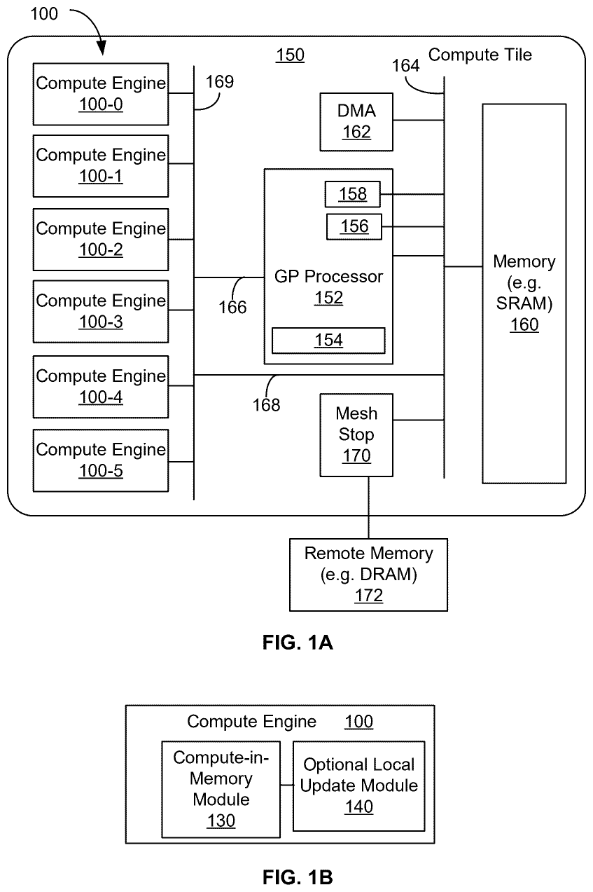

FIGS. 1A-1B depict an embodiment of a portion of compute engine 100 usable in an accelerator for a learning network and compute tile 150 (i.e. an embodiment of the environment) in which the compute engine may be used. FIG. 1A depicts compute tile 150 in which compute engine 100 may be used. FIG. 1B depicts compute engine 100. Compute engine 100 may be part of an AI accelerator that can be deployed for using a model (not explicitly depicted) and, in some embodiments, for allowing for on-chip training of the model (otherwise known as on-chip learning). Referring to FIG. 1A, system 150 is a compute tile and may be considered to be an artificial intelligence (AI) accelerator having an efficient architecture. Compute tile (or simply “tile”) 150 may be implemented as a single integrated circuit. Compute tile 150 includes a general purpose (GP) processor 110 and compute engines 100-0 through 100-5 (collectively or generically compute engines 100) which are analogous to compute engine 100 depicted in FIG. 1A. Also shown are on-tile memory 160 (which may be an SRAM memory) direct memory access (DMA) unit 162, and mesh stop 170. Thus, compute tile 150 may access remote memory 172, which may be DRAM. Remote memory 172 may be used for long term storage. In some embodiments, compute tile 150 may have another configuration. Further, additional or other components may be included on compute tile 150 or some components shown may be omitted. For example, although six compute engines 100 are shown, in other embodiments another number may be included. Similarly, although on-tile memory 160 is shown, in other embodiments, memory 160 may be omitted. GP processor 152 is shown as being coupled with compute engines 100 via compute bus (or other connector) 169 and bus 166. Compute engines 100 are also coupled to bus 164 via bus 168. In other embodiments, GP processor 152 may be connected with compute engines 100 in another manner.

In some embodiments, GP processor 152 is a reduced instruction set computer (RISC) processor. For example, GP processor 152 may be a RISC-V processor or ARM processor. In other embodiments, different and/or additional general purpose processor(s) may be used. The GP processor 152 provides control instructions and, in some embodiments, data to the compute engines 100. GP processor 152 may thus function as part of a control plane for (i.e. providing commands) and is part of the data path for compute engines 100 and tile 150. GP processor 152 may also perform other functions. GP processor 152 may apply activation function(s) to data. For example, an activation function (e.g. a ReLu, Tan h, and/or SoftMax) may be applied to the output of compute engine(s) 100. Thus, GP processor 152 may perform nonlinear operations. GP processor 152 may also perform linear functions and/or other operations. However, GP processor 152 is still desired to have reduced functionality as compared to, for example, a graphics processing unit (GPU) or central processing unit (CPU) of a computer system with which tile 150 might be used.

In some embodiments, GP processor includes an additional fixed function compute block (FFCB) 154 and local memories 156 and 158. In some embodiments, FFCB 154 may be a single instruction multiple data arithmetic logic unit (SIMD ALU). In some embodiments, FFCB 154 may be configured in another manner. FFCB 154 may be a close-coupled fixed-function unit for on-device inference and training of learning networks. In some embodiments, FFCB 154 executes nonlinear operations, number format conversion and/or dynamic scaling. In some embodiments, other and/or additional operations may be performed by FFCB 154. FFCB 154 may be coupled with the data path for the vector processing unit of GP processor 1310. In some embodiments, local memory 156 stores instructions while local memory 158 stores data. GP processor 152 may include other components, such as vector registers, that are not shown for simplicity.

Memory 160 may be or include a static random access memory (SRAM) and/or some other type of memory. Memory 160 may store activations (e.g. input vectors provided to compute tile 150 and the resultant of activation functions applied to the output of compute engines 100). Memory 160 may also store weights. For example, memory 160 may contain a backup copy of the weights or different weights if the weights stored in compute engines 100 are desired to be changed. In some embodiments, memory 160 is organized into banks of cells (e.g. banks of SRAM cells). In such embodiments, specific banks of memory 160 may service specific one(s) of compute engines 100. In other embodiments, banks of memory 160 may service any compute engine 100.

Mesh stop 172 provides an interface between compute tile 150 and the fabric of a mesh network that includes compute tile 150. Thus, mesh stop 172 may be used to communicate with remote DRAM 190. Mesh stop 172 may also be used to communicate with other compute tiles (not shown) with which compute tile 150 may be used. For example, a network on a chip may include multiple compute tiles 150, a GPU or other management processor, and/or other systems which are desired to operate together.

Compute engines 100 are configured to perform, efficiently and in parallel, tasks that may be part of using (e.g. performing inferences) and/or training (e.g. performing inferences and/or updating weights) a model. Compute engines 100 are coupled with and receive commands and, in at least some embodiments, data from GP processor 152. Compute engines 100 are modules which perform vector-matrix multiplications (VMMs) in parallel. Thus, compute engines 100 may perform linear operations. Each compute engine 100 includes a compute-in-memory (CIM) hardware module (shown in FIG. 1A). The CIM hardware module stores weights corresponding to a matrix and is configured to perform a VMM in parallel for the matrix.

Compute engines 100 may also include local update (LU) module(s) (shown in FIG. 1A). Such LU module(s) allow compute engines 100 to update weights stored in the CIM. In some embodiments, such LU module(s) may be omitted.

Referring to FIG. 1B, compute engine 100 includes CIM hardware module 130 and optional LU module 140. Although one CIM hardware module 130 and one LU module 140 is shown, a compute engine may include another number of CIM hardware modules 130 and/or another number of LU modules 140. For example, a compute engine might include three CIM hardware modules 130 and one LU module 140, one CIM hardware module 130 and two LU modules 140, or two CIM hardware modules 130 and two LU modules 140.

CIM hardware module 130 is a hardware module that stores data and performs operations. In some embodiments, CIM hardware module 130 stores weights for the model. CIM hardware module 130 also performs operations using the weights. More specifically, CIM hardware module 130 performs vector-matrix multiplications, where the vector may be an input vector provided and the matrix may be weights (i.e. data/parameters) stored by CIM hardware module 130. Thus, CIM hardware module 130 may be considered to include a memory (e.g. that stores the weights) and compute hardware, or compute logic, (e.g. that performs in parallel the vector-matrix multiplication of the stored weights). In some embodiments, the vector may be a matrix (i.e. an nxm vector where n>1 and m>1). For example, CIM hardware module 130 may include an analog static random access memory (SRAM) having multiple SRAM cells and configured to provide output(s) (e.g. voltage(s)) corresponding to the data (weight/parameter) stored in each cell of the SRAM multiplied by a corresponding element of the input vector. In some embodiments CIM hardware module 130 may include a digital static SRAM having multiple SRAM cells and configured to provide output(s) corresponding to the data (weight/parameter) stored in each cell of the digital SRAM multiplied by a corresponding element of the input vector. hardware voltage(s) corresponding to the impedance of each cell multiplied by the corresponding clement of the input vector. Other configurations of CIM hardware module 230 are possible. Each CIM hardware module 130 thus stores weights corresponding to a matrix in its cells and is configured to perform a vector-matrix multiplication of the matrix with an input vector.

In order to facilitate on-chip learning, LU module 140 may be provided. LU module 140 is coupled with the corresponding CIM hardware module 130. LU module 140 is used to update the weights (or other data) stored in CIM hardware module 130. LU module 140 is considered local because LU module 140 is in proximity with CIM module 130. For example, LU module 140 may reside on the same integrated circuit as CIM hardware module 130. In some embodiments LU module 140 for a particular compute engine resides in the same integrated circuit as the CIM hardware module 130. In some embodiments, LU module 140 is considered local because it is fabricated on the same substrate (e.g. the same silicon wafer) as the corresponding CIM hardware module 130. In some embodiments, LU module 140 is also used in determining the weight updates. In other embodiments, a separate component may calculate the weight updates. For example, in addition to or in lieu of LU module 140, the weight updates may be determined by a GP processor, in software by other processor(s) not part of compute engine 100 and/or the corresponding AI accelerator, by other hardware that is part of compute engine 100 and/or the corresponding AI accelerator, by other hardware outside of compute engine 100 or the corresponding Al accelerator.

Using compute engine 100 efficiency and performance of a learning network may be improved. Use of CIM hardware modules 130 may dramatically reduce the time to perform the vector-matrix multiplication that provides the weighted signal. Thus, performing inference(s) using compute engine 100 may require less time and power. This may improve efficiency of training and use of the model. LU modules 140 allow for local updates to the weights in CIM hardware modules 130. This may reduce the data movement that may otherwise be required for weight updates. Consequently, the time taken for training may be greatly reduced. In some embodiments, the time taken for a weight update using LU modules 140 may be an order of magnitude less (i.e. require one-tenth the time) than if updates are not performed locally. Efficiency and performance of a learning network provided using system 100 may be increased.

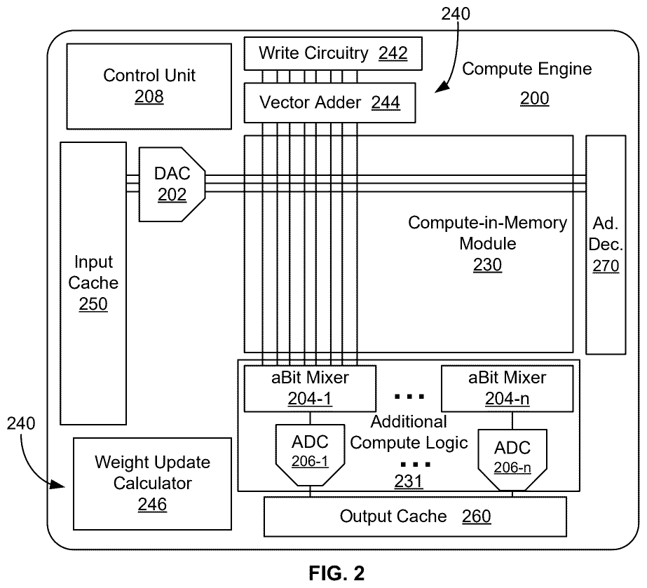

FIG. 2 depicts an embodiment of compute engine 200 usable in an AI accelerator and that may be capable of performing local updates. Compute engine 200 may be a hardware compute engine analogous to compute engine 100. Compute engine 200 thus includes CIM hardware module 230 and optional LU module 240 analogous to CIM hardware modules 130 and LU modules 140, respectively. Compute engine 200 includes input cache 250, output cache 260, and address decoder 270. Additional compute logic 231 is also shown. In some embodiments, additional compute logic 231 includes analog bit mixer (aBit mixer) 204-1 through 204-n (generically or collectively 204), and analog to digital converter(s) (ADC(s)) 206-1 through 206-n (generically or collectively 206). However, for a fully digital CIM hardware module 230, additional compute logic 231 may include logic such as adder trees and accumulators. In some embodiments, such logic may simply be included as part of CIM hardware module 230. In some embodiments, therefore, the output of CIM hardware module 230 may be provided to output cache 260. Although particular numbers of components 202, 204, 206, 230, 231, 240, 242, 244, 246, 260, and 270 are shown, another number of one or more components 202, 204, 206, 230, 231, 240, 242, 244, 246, 160, and 270 may be present. Further, in some embodiments, particular components may be omitted or replaced. For example, DAC 202, analog bit mixer 204, and ADC 206 may be present only for analog weights.

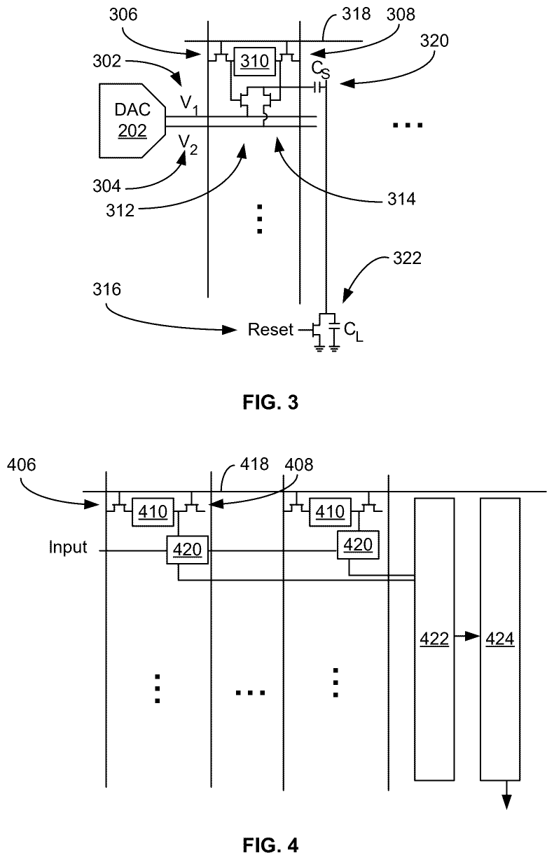

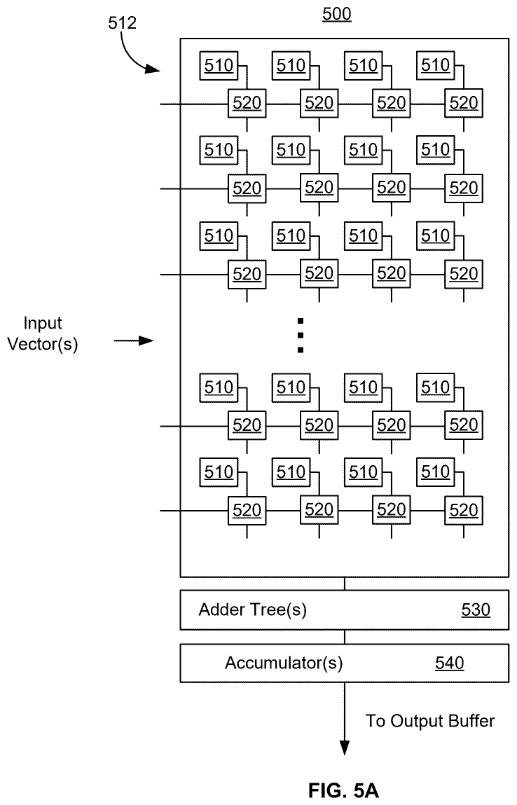

CIM hardware module 230 is a hardware module that stores data corresponding to weights and performs vector-matrix multiplications. The vector is an input vector provided to CIM hardware module 230 (e.g. via input cache 250) and the matrix includes the weights stored by CIM hardware module 230. In some embodiments, the vector may be a matrix. Examples of embodiments CIM modules that may be used in CIM hardware module 230 are depicted in FIGS. 3 and 4.

FIG. 3 depicts an embodiment of a cell in one embodiment of an SRAM CIM module usable for CIM hardware module 230. Also shown is DAC 202 of compute engine 200. For clarity, only one SRAM cell 310 is shown. However, multiple SRAM cells 310 may be present. For example, multiple SRAM cells 310 may be arranged in a rectangular array. An SRAM cell 310 may store a weight or a part of the weight. The CIM hardware module shown includes lines 302, 304, and 318, transistors 306, 308, 312, 314, and 316, capacitors 320 (C_{S}) and 322 (C_{L}). In the embodiment shown in FIG. 3, DAC 202 converts a digital input voltage to differential voltages, V₁ and V₂, with zero reference. These voltages are coupled to each cell within the row. DAC 202 is thus used to temporal code differentially. Lines 302 and 304 carry voltages V₁ and V₂, respectively, from DAC 202. Line 318 is coupled with address decoder 270 (not shown in FIG. 3) and used to select cell 310 (and, in the embodiment shown, the entire row including cell 310), via transistors 306 and 308.

In operation, voltages of capacitors 320 and 322 are set to zero, for example via Reset provided to transistor 316. DAC 202 provides the differential voltages on lines 302 and 304, and the address decoder (not shown in FIG. 3) selects the row of cell 310 via line 318. Transistor 312 passes input voltage V₁ if SRAM cell 310 stores a logical 1, while transistor 314 passes input voltage V₂ if SRAM cell 310 stores a zero. Consequently, capacitor 320 is provided with the appropriate voltage based on the contents of SRAM cell 310. Capacitor 320 is in series with capacitor 322. Thus, capacitors 320 and 322 act as capacitive voltage divider. Each row in the column of SRAM cell 310 contributes to the total voltage corresponding to the voltage passed, the capacitance, C_{S}, of capacitor 320, and the capacitance, C_{L}, of capacitor 322. Each row contributes a corresponding voltage to the capacitor 322. The output voltage is measured across capacitor 322. In some embodiments, this voltage is passed to the corresponding aBit mixer 204 for the column. In some embodiments, capacitors 320 and 322 may be replaced by transistors to act as resistors, creating a resistive voltage divider instead of the capacitive voltage divider. Thus, using the configuration depicted in FIG. 3, CIM hardware module 230 may perform a vector-matrix multiplication using data stored in SRAM cells 310.

FIG. 4 depicts an embodiment of a cell in one embodiment of a digital SRAM module usable for CIM hardware module 230. For clarity, only one digital SRAM cell 410 is labeled. However, multiple cells 410 are present and may be arranged in a rectangular array. Also labeled are corresponding transistors 406 and 408 for each cell, line 418, logic gates 420, adder tree 422 and accumulator 424.

In operation, a row including digital SRAM cell 410 is enabled by address decoder 270 (not shown in FIG. 4) using line 418. Transistors 406 and 408 are enabled, allowing the data stored in digital SRAM cell 410 to be provided to logic gates 420. Logic gates 420 combine the data stored in digital SRAM cell 410 with the input vector. Thus, the binary weights stored in digital SRAM cells 410 are combined with (e.g. multiplied by) the binary inputs. Thus, the multiplication performed may be a bit serial multiplication. The output of logic gates 420 are added using adder tree 422 and combined by accumulator 424. Thus, using the configuration depicted in FIG. 4, CIM hardware module 230 may perform a vector-matrix multiplication using data stored in digital SRAM cells 410.

Referring back to FIG. 2, CIM hardware module 230 thus stores weights corresponding to a matrix in its cells and is configured to perform a vector-matrix multiplication of the matrix with an input vector. In some embodiments, compute engine 200 stores positive weights in CIM hardware module 230. However, the use of both positive and negative weights may be desired for some models and/or some applications. In such cases, the sign may be accounted for by a sign bit or other mapping of the sign to CIM hardware module 230.

Input cache 250 receives an input vector for which a vector-matrix multiplication is desired to be performed. The input vector may be read from a memory, from a cache or register in the processor, or obtained in another manner. For analog cells, such as depicted in FIG. 3, digital-to-analog converter (DAC) 202 may convert a digital input vector to analog in order for CIM hardware module 230 to operate on the vector. Although shown as connected to only some portions of CIM hardware module 230, DAC 202 may be connected to all of the cells of CIM hardware module 230. Alternatively, multiple DACs 202 may be used to connect to all cells of CIM hardware module 230. Address decoder 270 includes address circuitry configured to selectively couple vector adder 244 and write circuitry 242 with each cell of CIM hardware module 230. Address decoder 270 selects the cells in CIM hardware module 230. For example, address decoder 270 may select individual cells, rows, or columns to be updated, undergo a vector-matrix multiplication, or output the results. In some embodiments, aBit mixer 204 combines the results from CIM hardware module 230. Use of aBit mixer 204 may save on ADCs 206 and allows access to analog output voltages. ADC(s) 206 convert the analog resultant of the vector-matrix multiplication to digital form. Output cache 260 receives the result of the vector-matrix multiplication and outputs the result from compute engine 200. Thus, a vector-matrix multiplication may be performed using CIM hardware module 230 and cells 310.

For a digital SRAM CIM module, input cache 250 may serialize an input vector. The input vector is provided to CIM hardware module 230. As previously indicated, DAC 202 may be omitted for a digital CIM hardware module 230, for example which uses digital SRAM storage cells 410. Logic gates 420 combine (e.g., multiply) the bits from the input vector with the bits stored in SRAM cells 410. The output is provided to adder trees 422 and to accumulator 424. In some embodiments, therefore, adder trees 422 and accumulator 424 may be considered to be part of CIM hardware module 230. The resultant is provided to output cache 260. Thus, a digital vector-matrix multiplication may be performed in parallel using CIM hardware module 230.

LU module 240 includes write circuitry 242 and vector adder 244. In some embodiments, LU module 240 includes weight update calculator 246. In other embodiments, weight update calculator 246 may be a separate component and/or may not reside within compute engine 200. Weigh update calculator 246 is used to determine how to update to the weights stored in CIM hardware module 230. In some embodiments, the updates are determined sequentially based upon target outputs for the learning system of which compute engine 200 is a part. In some embodiments, the weight update provided may be sign-based (e.g. increments for a positive sign in the gradient of the loss function and decrements for a negative sign in the gradient of the loss function). In some embodiments, the weight update may be ternary (e.g. increments for a positive sign in the gradient of the loss function, decrements for a negative sign in the gradient of the loss function, and leaves the weight unchanged for a zero gradient of the loss function). Other types of weight updates may be possible. In some embodiments, weight update calculator 246 provides an update signal indicating how each weight is to be updated. The weight stored in a cell of CIM hardware module 230 is sensed and is increased, decreased, or left unchanged based on the update signal. In particular, the weight update may be provided to vector adder 244, which also reads the weight of a cell in CIM hardware module 230. More specifically, adder 244 is configured to be selectively coupled with each cell of CIM hardware module by address decoder 270. Vector adder 244 receives a weight update and adds the weight update with a weight for each cell. Thus, the sum of the weight update and the weight is determined. The resulting sum (i.e. the updated weight) is provided to write circuitry 242. Write circuitry 242 is coupled with vector adder 244 and the cells of CIM hardware module 230. Write circuitry 242 writes the sum of the weight and the weight update to each cell. In some embodiments, LU module 240 further includes a local batched weight update calculator (not shown in FIG. 2) coupled with vector adder 244. Such a batched weight update calculator is configured to determine the weight update.

Compute engine 200 may also include control unit 208. Control unit 208 generates the control signals depending on the operation mode of compute engine 200. Control unit 240 is configured to provide control signals to CIM hardware module 230 and LU module 1549. Some of the control signals correspond to an inference mode. Some of the control signals correspond to a training, or weight update mode. In some embodiments, the mode is controlled by a control processor (not shown in FIG. 2, but analogous to processor 110) that generates control signals based on the Instruction Set Architecture (ISA).

Using compute engine 200, efficiency and performance of a learning network may be improved. CIM hardware module 230 may dramatically reduce the time to perform the vector-matrix multiplication. Thus, performing inference(s) using compute engine 200 may require less time and power. This may improve efficiency of training and use of the model. LU module 240 may perform local updates to the weights stored in the cells of CIM hardware module 230. This may reduce the data movement that may otherwise be required for weight updates. Consequently, the time taken for training may be dramatically reduced. Efficiency and performance of a learning network provided using compute engine 200 may be increased.

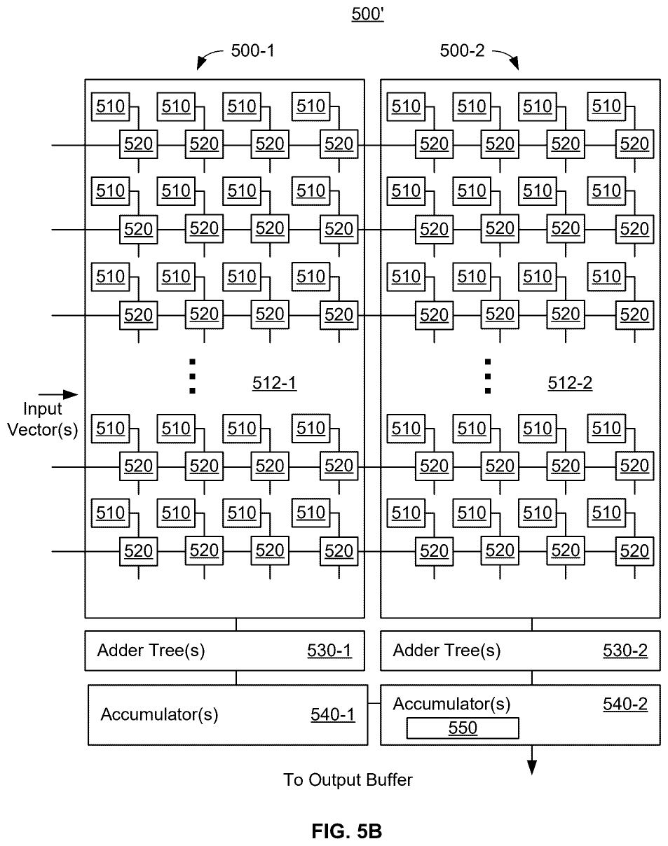

FIGS. 5A-5C depict embodiments of portions of a compute engine that may be hierarchically organized and/or scaled. FIG. 5A depicts an embodiment of a CIM module block 500 which may be scaled. CIM module block 500 may be used in CIM hardware module(s) 130 and/or 230 of compute engines 100 and/or 200 of compute tiles such as compute tile 150. CIM module block 500 includes storage cells 510 and compute logic. Storage cells 510 may be considered to be organized into array 512. Compute logic includes logic gates 520, adder tree(s) 530, and accumulator(s) 540. Logic gates 520 are coupled with storage cells 510 and perform a bit wise multiplication of the data in the corresponding storage cell 510 and the input vector. Logic gates 520 may be considered part of array 512. Although shown separately from array 512 and connected via a single line, adder tree(s) 530 and accumulator 540 are connected with logic gates 520 in array 512 to perform a VMM. Storage cells 510 in array 512 may share at least a portion (e.g. adder trees 530 and accumulator(s) 540) of compute logic 520, 530, and 540. Although described in the context of a digital CIM module, nothing prevents the use of analog modules, for example storage of weights in resistive cells or other analogous cells.

In the embodiment shown, array 512 includes four columns and a number of rows. In some embodiment, array 512 includes one hundred and twenty-eight rows. However, another number of rows and/or columns may be used. For example, array 512 might include eight columns and one hundred and twenty-eight rows or four columns and two hundred and fifty-six columns of storage cells 510. In the embodiment shown, each storage cell 510 stores one bit. A weight, or portion thereof, may be stored in each row of array 512. Thus, CIM module block 500 may store 4-bit weights or 4 bits of a larger weight (e.g. 4 bits of an 8-bit weight) per row. CIM module block 500 may be considered to have a base precision given by the number of storage cells 510 in a row. Stated differently, the base precision of CIM module block 500 is the maximum of bits that may be stored in a row of array 512. Thus, CIM module block 500 may be considered to have a base precision of four bits. For CIM module block 500 having one hundred and twenty-eight rows, CIM module block 500 may store one hundred and twenty-eight 4-bit weights.

Compute logic 520, 530 and 540 is coupled with storage cells 510. Logic gates 520 of compute logic 520, 530, and 540 perform bit-wise multiplication of the elements of an input vector with the weights stored in rows of array 512. Adder tree(s) 530 and accumulator(s) 540 appropriately add the products of the bit-wise multiplications and provide a VMM for CIM module block 500.

CIM module block 500 may be considered to be formed of a storage block including storage cells 510 in array 512 and a compute logic block formed by logic gates 520, adder tree(s) 530, and accumulator(s) 540 of compute logic 520, 530, and 540. CIM module block 500 may be scaled hierarchically.

For example, FIG. 5B depicts a CIM module block pair 500′. CIM module block pair 500′ includes of CIM module blocks 500-1 and 500-2. Each CIM module block 500-1 and 500-2 is analogous to CIM module block 500. Thus, CIM module block 500-1 includes array 512-1 analogous to array 512, adder tree(s) 530-1 analogous to adder tree(s) 530, and accumulator(s) 540-1 analogous to accumulator(s) 540. Similarly, CIM module block 500-2 includes array 512-2 analogous to array 512, adder tree(s) 530-2 analogous to adder tree(s) 530, and accumulator(s) 540-2 analogous to accumulator(s) 540. Thus, each CIM module block 500-1 and 500-2 has a base precision of four bits. CIM module block pair 500′ has a precision of eight bits. Thus, each row of CIM module block pair 500′ may store an 8-bit weight or two 4-bit weights.

CIM module block pair 500′ also includes merge logic 550. In the embodiment shown, merge logic is incorporated into accumulator(s) 540-2. Thus, accumulators 540-1 and 540-2 are connected. However, in other embodiments, merge logic 550 may be provided separately. In such embodiments, accumulators 540-1 and 540-2 are both connected to merge logic 550.

Merge logic 550 allows the VMMs for each CIM module block 550-1 and 550-2 to be combined. Thus, merge logic 550 allows CIM module block pair 550 having a base precision of four bits to be utilized with 8-bit weights. Further, merge logic 550 may be selectively enabled. For example, for CIM module block pair 500′ may be used to perform VMMs for 4-bit weights if merge logic 550 is disabled throughout use. If merge logic 550 is used, CIM module block pair 500′ may perform VMMs for 8-bit weights. To do so, VMMs are performed for 4-bit portions of the weights by CIM module blocks 500-1 and 500-2. For example, CIM module block 500-2 may perform the VMM for the four least significant bits (the LSB nibble) of the 8-bit weight, while CIM module block 500-2 may perform the VMM for the four most significant bits (the MSB nibble) of the 8-bit weight. Merge logic 550 may then be enabled to combine the VMMs performed by each block 500-1 and 500-2. In so doing, merge logic 550 accounts for the differences in values of the MSB nibble and the LSB nibble.

CIM module block pair 500′ may be further scaled and/or used to provide a CIM hardware module, such as CIM hardware module(s) 130 and/or 230, having the desired number of weights. For example, FIG. 5C depicts two CIM module block pairs 500-1′ and 500-2′. CIM module block pair 500-1′ includes CIM module blocks 500-11 and 500-12 that are analogous to CIM module blocks 500-1 and 500-2, respectively. Similarly, CIM module block pair 500-2′ includes CIM module blocks 520-11 and 500-22 that are analogous to CIM module blocks 500-1 and 500-2, respectively. For example, CIM module blocks 500-11 and 500-21 each include an array 512-1, adder(s) 530-1, and accumulator(s) 540-1. CIM module blocks 500-12 and 500-22 each include an array 512-2, adder(s) 530-2, and accumulator(s) 540-2 incorporating merge logic 550-1 and 550-2, respectively. Merge logic 550-1 and 550-2 are analogous to merge logic 550. Thus, CIM module block pairs 500-1′ and 500-2′ may be used to store and perform VMMs for four columns of 4-bit weights or two columns of 8-bit weights.

Thus, CIM module block 500 may be used to provide improved flexibility and scalability of the compute engines in which CIM module block 500 is incorporate. CIM module block 500 allows for improved flexibility in the precision of the weights being stored. For example, CIM block 500 may be used for weights having the base precision (e.g. 4-bit weights) or may be operated in conjunction with other CIM module block(s) 500 for weights having multiples of the base precision (e.g. 8-bit weights or 16-bit weights). In some embodiments, additional merge logic analogous to merge logic 550 may be used for higher multiples of the base precision (e.g. for 16-bit weights). Because each CIM module block 500 may be a standalone block, multiple CIM module blocks 500 may be more readily combined. Thus, scaling to larger numbers of weights and/or higher precision weights is simplified. Further, CIM module block 500 may still operate using bit serial operations. Thus, power may still be conserved. Other advantages of compute tile 150, compute engine(s) 100 and 200, and CIM hardware modules 130 and/or 230 may be maintained. Thus, performance, scaling, and flexibility of a hardware accelerator may be improved.

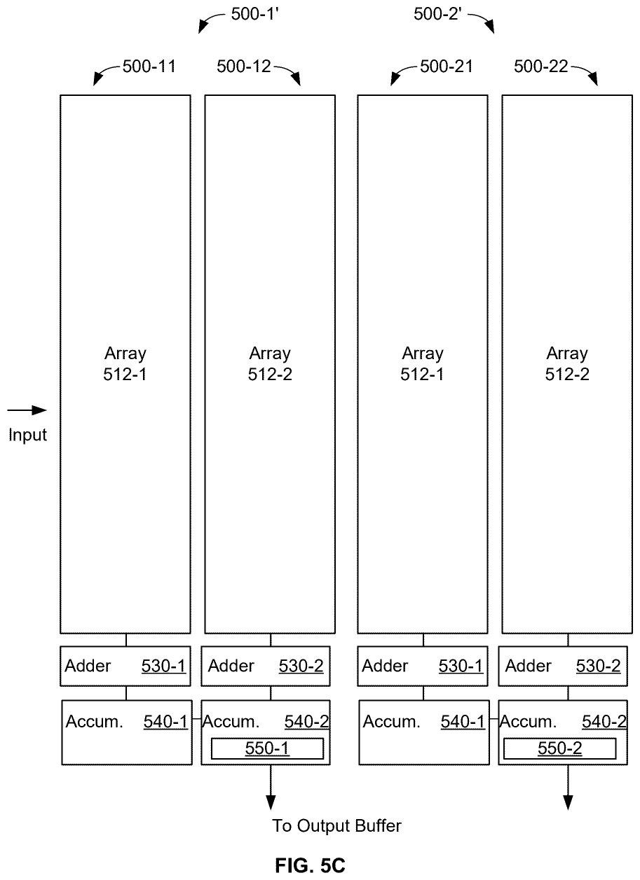

FIG. 6 depicts an embodiment of a portion of a compute-in-memory hardware module that may be hierarchically organized and/or scaled. More specifically, FIG. 6 depicts an embodiment of a CIM module block 600 which may be scaled. CIM module block 600 may be used in CIM hardware module(s) 130 and/or 230 of compute engines 100 and/or 200 of compute tiles such as compute tile 150. CIM module block 600 includes storage cells (not explicitly shown) and compute logic 601. The storage cells for CIM module block 600 may be analogous to storage cells 410 and/or 510 and are organized into array 612. Compute logic 601 includes logic gates 620, adder tree 630, and accumulator 640. Logic gates 620 are coupled with storage cells of storage cell array 612 and perform a bit wise multiplication of the data in the corresponding storage cell 610 and the elements of the input vector. Although described in the context of a digital CIM module, nothing prevents the use of analog modules, for example storage of weights in resistive cells or other analogous cells.

Although not expressly shown, array 612 may include four columns and a number of rows. For example, in some embodiment, array 612 includes one hundred and twenty-eight rows. However, another number of rows and/or columns may be used. In the embodiment shown, each storage cell 610 stores one bit. Thus, CIM module block 600 may be considered to have a base precision of four bits.

Adder tree 630 is coupled with logic gates 620 and includes adders 632, 634, and 636 that are organized hierarchically in a tree. The number of bits is indicated on the lines. Thus, adder 632 receives four bit inputs from logic gates 620 and provides a five-bit output. Adder tree 630 combines thus includes ten-bit adder 636 and provide eleven bit output to accumulator 640. Although shown separately from array 512 and connected via a single line, adder tree(s) 530 and accumulator 540 are connected with logic gates 520 in array 512 to perform a VMM.

CIM module block 600 is analogous to CIM module block 500 and may be scaled in an analogous manner. For example, two CIM module blocks 600 may be used in conjunction with merge logic (not shown in FIG. 6) to form a CIM module block pair that may be used with higher precision weights. Multiple CIM module blocks 600 and/or multiple pairs of CIM module blocks 600 may thus be combined.

CIM module block 600 may be used to provide improved flexibility and scalability of the compute engines in which CIM module block 600 is incorporated. CIM module block 600 may be used with weights having different precisions. Because each CIM module block 600 may be a standalone block, multiple CIM module blocks 500 may be more readily combined. Thus, scaling to larger numbers of weights and/or higher precision weights is simplified. Further, CIM module block 600 may still operate using bit serial operations. Thus, power may still be conserved. Other advantages of compute tile 150, compute engine(s) 100 and 200, and CIM hardware modules 130 and/or 230 may be maintained. Thus, performance, scaling, and flexibility of a hardware accelerator may be improved.

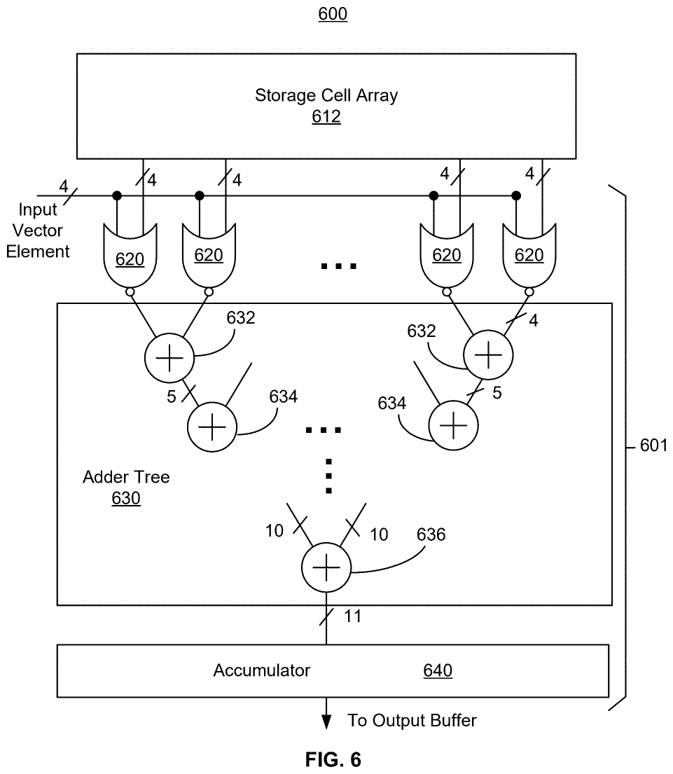

FIG. 7 depicts an embodiment of a portion of a compute-in-memory hardware module that may be hierarchically organized and/or scaled. More specifically, FIG. 7 depicts accumulators 700 that may be used for CIM module block pair 500′, 500-1′ and/or 500-2′. Thus, accumulators 700 are described in the context of a 4-bit base precision for each CIM module block with which accumulators 700 are used. However, accumulators 700 may be extended to other base precisions. Also shown are ten bit adders 702-1 and 702-2 that may be part of adder trees used in conjunction with accumulators 700. For example, adders 702-1 and 702-2 may be analogous to adder 636 shown in CIM module block 600. Although not separately shown, adders 702-1 and 702-2 may have multiple stages.

Accumulators 700 include most significant bit (MSB) accumulator 710-1 and least significant bit (LSB) accumulator 710-2. MSB accumulator 710-1 and LSB 710-2 are analogous. However, merge logic 750 (including components 752, 754, and 756) has been incorporated into accumulators 700. In some embodiments, merge logic 750 may be considered to be incorporated into LSB accumulator 710-2. In other embodiments, separate circuitry may be used to combined the VMMs of MSB accumulator 710-1 and LSB accumulator 710-2. MSB accumulator 710-1 may be used for the VMM of the MSB nibble of an 8-bit weights, while LSB accumulator 710-2 may be used for the VMM of the LSB nibble of an 8-bit weights. If the weights stored have the base precision (e.g. 4-bit precision), then MSB accumulator 710-1 is used for a VMM of one set of weights, while LSB accumulator 710-2 is used for another set of weights. In such an embodiment, merge logic 750 may not be enabled during use.

MSB accumulator 710-1 includes components 712-1, 714-1, 716-1, 720-1, 722-1, and 724-1. Similarly, LSB accumulator 710-2 includes components 712-2, 714-2, 716-2, 720-2, 722-2, and 724-2. In addition, portions 754 and 756 of merge logic 750 are incorporated into LSB accumulator 710-2. In operation, the output of adder 702-1 is received at MSB accumulator and provided to components 714-land 714-2. Based on the value of the MSign (which is related to the sign bit of the MSB nibble of the weight), multiplexer 712-1 provides the appropriate output to sign extender 716-1. The products of the MSB nibbles of the 8-bit weights (or 4-bit weights) and the input vector are accumulated in 19-bit adder 720-1. Although not separately shown, 19-bit adder 720-1 may have multiple stages. LSB accumulator 710-2 operates in an analogous manner to MSB accumulator 710-1. Thus, the products of LSB nibbles of the 8-bit weights (or the 4-bit weights) are accumulated by 19-bit adder 720-2.

For 8-bit weights, the LSB nibble and MSB nibble share a sign. However, for 4-bit weights, the signs of the weights used by LSB accumulator 710-2 may be different from the signs of the weights used by MSB accumulator 710-1. For 4-bit weights, the weights corresponding to LSB accumulator 710-2 carry their own sign information. Thus, the value of MSign and LSign used by multiplexers 712-1 and 712-2 depends upon the sign of the weight and whether 4-bit or 8-bit weights are being accumulated. Table 1 indicates the values of the MSign and LSign for the weight mode (whether 4-bit or 8-bit weights are being used) and the MSB sign for some embodiments of accumulators 700. However, other techniques for encoding sign information may be used in other embodiments.

TABLE 1

| WMode | MSB | MSign | LSign |
|---|---|---|---|
| 0 | 0 | 0 | 0 |
| 0 | 1 | 1 | 1 |
| 1 | 0 | 0 | 0 |
| 1 | 1 | 1 | 0 |

In some embodiments, MSB accumulator 710-1 and LSB accumulator 710-2 accumulate their VMMs in a particular number of cycles. For example, for 8-bit weights and CIM module blocks having four columns, MSB accumulator 710-1 and LSB accumulator 710-2 accumulate the VMM in eight cycles. Once adders 720-1 and 720-2 complete the resultants for their corresponding CIM module block, the resultants may be merged. In such embodiments, a merge signal in subsequent cycles may be used to activate AND gate 752 and multiplexers 754 and 756. Thus, the resultant from storage 722-1 is shifted by four bits (for a 4-bit base precision) and provided to 19-bit adder 720-2 via AND gate 752 and multiplexer 756. The resultants of LSB accumulator 710-2 are provided from storage 722-2 to 19-bit adder 720-2. Thus, the VMM completed by MSB accumulator 710-1 and the VMM completed by LSB accumulator 710-2 may be added and provided to multiplexer 740 to be output. In some embodiments, 19-bit adder 720-2 need not be reused to merge the resultants of LSB accumulator 720-2 and MSB accumulator 720-1. In such embodiments, a separate adder may be used. In contrast, if 4-bit weights are accumulated, merge logic 750 is not enabled. Thus, storage 722-1 and 722-2 simply output their results to multiplexer 740.

Multiplexer 740 may be an inherently latching multiplexer. Thus, the output of multiplexer 740 remains constant unless and until new output is read from multiplexer 740. Thus, multiplexer 740 does not change state in response to other conditions. In some embodiment, multiplexer 740 need not be a latching multiplexer. However, in some such embodiments, flops may be used in conjunction with such a multiplexer 740 to stabilize the output. Multiplexer 740 is depicted as being incorporated into accumulators 700. However, in some embodiments, multiplexer 740 may be considered to be separate. Such a separate multiplexer might be used in conjunction with multiple CIM module block pairs.

Accumulators 700 may be used as part of CIM module blocks, such as CIM module blocks 500 and/or 600 to provide improved flexibility and scalability of the compute engines in which accumulators 700 are incorporated. Accumulators 700 and the CIM module blocks may be used with weights having different precisions. Because each CIM module block pair may be standalone, multiple CIM module block pairs using accumulators 700 may be more readily combined. Thus, scaling to larger numbers of weights and/or higher precision weights is simplified. Further, a CIM module block pair using accumulators 700 may still operate using bit serial operations. Thus, power may still be conserved. Other advantages of compute tile 150, compute engine(s) 100 and 200, and CIM hardware modules 130 and/or 230 may be maintained. Thus, performance, scaling, and flexibility of a hardware accelerator may be improved.

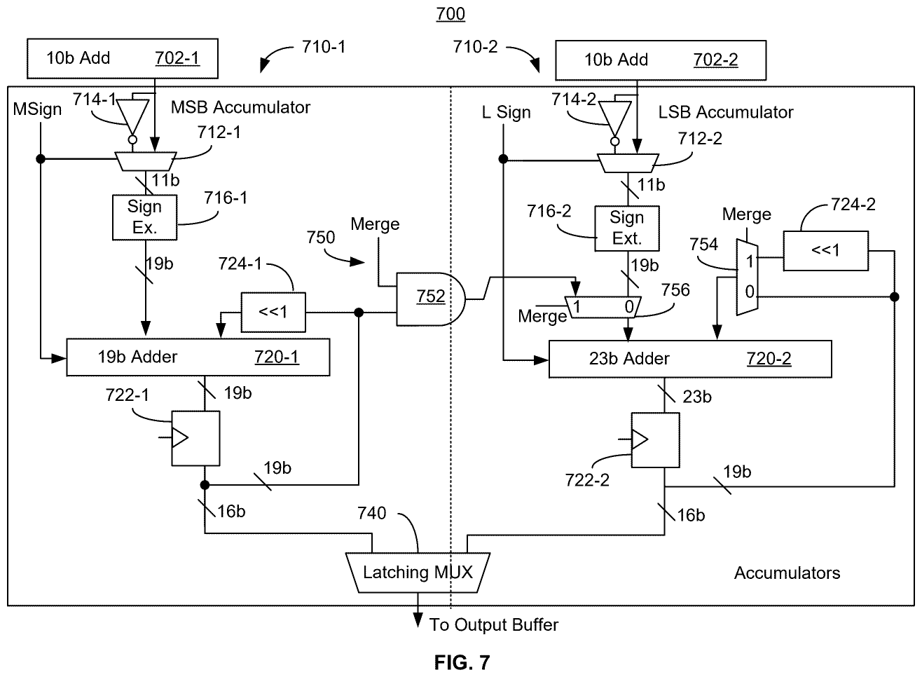

Power management is also desirable for compute tiles and compute engines, such as compute tile 150 and compute engines 100 and/or 200. FIG. 8 depicts a portion of compute engine 800 for which power is managed. In particular, power usage for compute engine may be primarily divided into circuitry corresponding to three functions, or regions: compute logic 810, update circuitry 820, and storage cells 830. Compute engine 800 is described in the context of CIM module block 500 and compute engine 200. Compute logic 810 may include circuitry used in performing VMMs, such as logic gates 520, adders 530, and accumulators 540. Other circuitry may also be part of compute logic. Update circuitry 820 is used in updating data stored in the storage cells, such as storage cells 510. Thus, update circuitry 820 may be used in writing weights, rewriting weights, updating weights, or otherwise modifying the contents of storage cells 510. Storage cells 830 may include bit cells 510 of array 512. Thus, storage cells 830 may include SRAM and/or other cells used in storing weights.

Compute engine 800 also includes power units 842, 844, and 846. Compute logic power unit 842 controls power to compute logic 810. Update power unit 844 controls power to update circuitry 820. Storage cell power unit 846 controls power to storage cells 830. Thus, power units 842, 844, and 846 allow for power management for different portions of compute engine 800. During operation, power units 842, 844, and 846 also provide the appropriate power for the corresponding regions. For example, compute logic 810 may draw more power during operation than storage cells 830. In such embodiments, compute logic power unit 842 provides more power to compute logic 810 than storage cell power unit 846 provides to storage cells 830. If not being used, power units 842, 844, and 846 may manage power to their corresponding regions 810, 820, and 830. Using power units 842, 844, and/or 846, compute logic 810, update circuitry 820, and storage cells 830 may be selectively provided with sufficient power for operation, sufficient power only for a low power or standby mode, and/or may be powered off. Although a single power unit 842, 844, and 846 are shown for each region 810, 820, and 830, in some embodiments, multiple power units may be provided for each region. Thus, the granularity with which power is controlled may be increased.

For example, update circuitry 820 may be used only when storing weights in storage cells 830. For a weight stationary architecture, the weights do not change for long periods of time. However, update circuitry 820 may consume some power while not in use. To prevent or reduce this power leakage, update power unit 844 may turn power off to update circuitry 820, but power units 842 and 846 provide power to compute logic 810 and storage cells 830.

Power units 842, 844, and 846 may also be used to power on/power off circuitry 810, 820, and 830 in the desired order. For example, suppose compute engine 800 is to be used with weights that have already been stored in storage cells 830. Power unit 846 provides power to storage cells 830. Power unit 842 may then provide power to compute logic 810. Because update circuitry 820 is rarely used update circuitry 820 may remain powered off. Thus, leakages or other power drains due to update circuitry 820 may be reduced or eliminated when update circuitry 820 is not used. The specifics of the amount of power or voltage, the order in which regions are powered on and/or powered off, the granularity with which power may be controlled, as well as other features of power units 842, 844, and 846 may be adapted to the particular embodiments in which they are used.

Compute engine 800 may have improved power management. Using power units 842, 844, and/or 846, power (as well as voltage and/or current) may be selectively provided to compute logic 810, update circuitry 820, and/or storage cells 830. For example, regions 810, 820, and/or 830 may be completely powered on (ready to perform its operations), put in a low power and/or standby mode, or completely turned off. As a result, compute engine 800 may be more efficient.

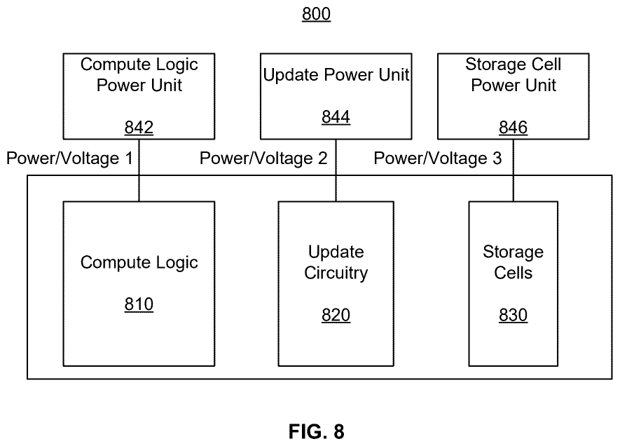

Power consumption by a compute engine and/or compute tile may be managed in other ways, for example during operation. FIGS. 9A-9B depict embodiments of portions of compute engines 900 and 900′, respectively, having managed driving of input vectors. Referring to FIG. 9A, a CIM hardware module, such as CIM hardware module 130 and/or 230, may be divided into banks 910-0, 910-1, 910-2, and 910-3 (collectively or generically 910). Each bank 910 includes multiple storage cells and portions of compute logic. For example, a CIM module bank 1 may include one or more CIM module blocks or block pairs. Compute engine 900 also includes input vector drivers 930 and repeaters 920-1 and 920-2 (collectively or generically 920), each of which includes logic gates 940. For simplicity, only one AND gate 940 is labeled.

As part of performing VMMs, elements of the input vectors are provided to the CIM hardware module. To do so, drivers 930 and repeaters 920 are used. Logic gates 940 are used control the driving of signals corresponding to elements of the input vector. For example, logic gates 940 may be AND gates. One input to each AND 940 gates is select signal (Select 0, Select 1, Select 2, or Select 3). The other input to each AND gate 940 may be the signal used in driving the corresponding bank. When the corresponding select signal is on, AND gates 940 allow the signals for the input vector elements to be driven to the corresponding bank. The select signal for a bank may be assigned during or after writing of weights to a particular bank. The select signal may be on only if the corresponding bank includes at least one storage cell being used for weight(s). For example, suppose CIM module bank 0 910-0, CIM module bank 1 910-1, and CIM module bank 2 910-2 store weights, but CIM module bank 3 910-3 does not store weights. Select signal Select 3 is off, while Select 0, Select 1 and Select 2 are on. Thus, AND gates 940 for repeater 920-2 are off. When a VMM is calculated, repeater 920-2 does not drive signals for the input vectors to CIM module bank 3 910-3. However, AND gates 940 for repeater 920-1 and input vector drivers 930 are on. Thus, signals for the input vectors are driven to CIM module bank 0 910-0, CIM module bank 1 910-1 and CIM module bank 2 910-2. VMMs are determined for CIM module banks 910-0, 910-1, and 910-2. Consequently, power leakage due to CIM module bank 3 may be reduced. Although described in the context of AND gates 940, other logic may be used. For example, OR gates and/other combinations of circuitry may be used to control driving.

FIG. 9B, compute engine 900′ utilizing different logic to control driving of the input vector through compute engine 900′. Compute engine 900′ includes a CIM hardware module, such as CIM hardware module 130 and/or 230, that is divided into banks 910-0, 910-1, 910-2, and 910-3 (collectively or generically 910) that are analogous to banks 910 of FIG. 9A. Compute engine 900 also includes input vector drivers 930 and repeaters 920-1′ and 920-2′ (collectively or generically 920′), each of which includes logic gates 940′. Thus, compute engine 900′ is analogous to compute engine 900. However, logic gates 940′ include tri-state inverters. Thus, multiple select signals Selects 0, Selects 1, Selects 2, or Selects 3, inverters 940′ may be used to control driving of the input vector through CIM module banks 910. As a result, unused banks 910 of compute engine 900′ do not participate in VMMs. Thus, power may be better managed.

Compute engines 900 and 900′ may have improved power management. Using logic gates 940 and/or 940′, power (as well as voltage and/or current) may be selectively provided to drive signals for the input vectors through various banks 910. Consequently, banks 910 that do not store weights do not participate in VMMs. Thus, leakage power may be reduced. As a result, compute engine 900 may be more efficient.

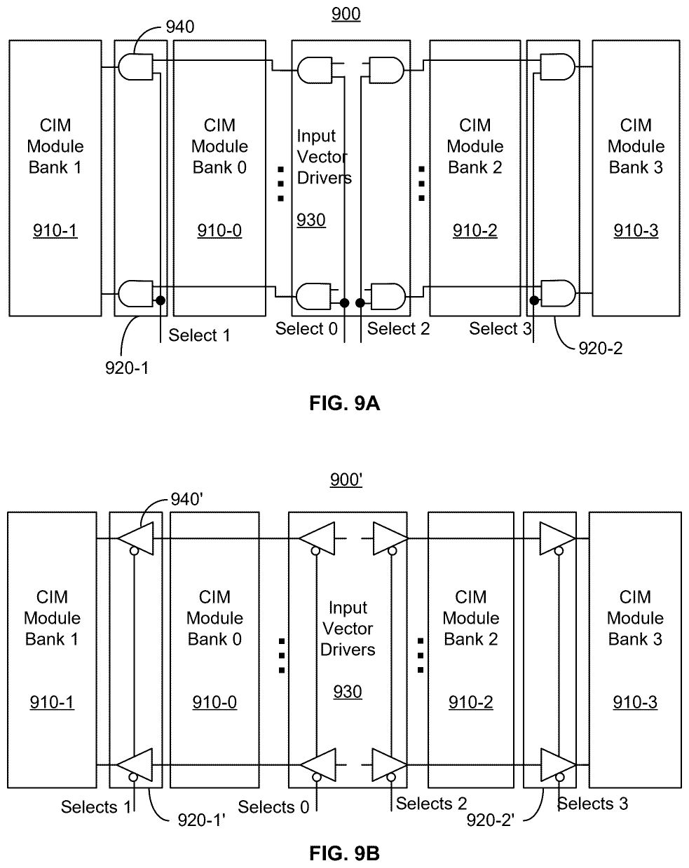

FIG. 10 is a flow-chart depicting an embodiment of method 1000 for using a compute engine that may be hierarchically organized or scaled. Method 1000 is described in the context of CIM module block 500. However, method 1000 is usable with CIM hardware modules 130, 200, and/or 600 and other compute engines and/or compute tiles. Although particular processes are shown in an order, the processes may be performed in another order, including in parallel. Further, processes may have substeps.

An input vector is provided to a CIM hardware module, at 1002. The CIM hardware module is arranged into CIM module blocks, each of which includes one or more logic blocks and one or more compute blocks. Using the CIM hardware module, the VMM is performed, at 1004. More specifically, because the CIM hardware module is arranged in CIM module blocks, the VMMs are performed in blocks. Thus, the compute logic block of each CIM module block performs a VMM for the portion of the matrix stored in the storage cells of the corresponding.

The CIM module blocks may be arranged in pairs. Further, each CIM module block in each pair may store a portion of the weight. Thus, at 1006, the outputs of each block in a pair of blocks are merged if each CIM module block stores only a portion of a weight in a row. At 1008, the output of the VMM is provided.

For example, suppose CIM module block pairs 500-1′ and 500-2′ are used. Also suppose that each row in a pair stores a weight. Thus, each row of a block stores a portion of the weight and the outputs are to be merged. At 1002 an input vector is provided to CIM module blocks 500-11, 500-12 and to CIM module blocks 500-21 and 500-22. At 1004 each bock 500-11, 500-12, 500-21, and 500-22 performs a VMM. Thus, the VMMs corresponding to each block are stored in accumulators 540-1 and 540-2. At 1006 a merge is performed using merge logic 550-1 and 550-2. Thus, the total VMM is provided to the output buffer, at 1008.

In contrast, suppose again that CIM module block pairs 500-1′ and 500-2′ are used. Also suppose that each row in a pair stores two weights. Thus, each row of a block stores a weight and the outputs are not to be merged. At 1002 an input vector is provided to CIM module blocks 500-11, 500-12 and to CIM module blocks 500-21 and 500-22. At 1004 each bock 500-11, 500-12, 500-21, and 500-22 performs a VMM. Thus, the VMMs corresponding to each block are stored in accumulators 540-1 and 540-2. At 1006 no merge is performed. Thus, the VMMs from each block 500-11, 500-12, 500-21, and 500-22 are provided to the output buffer, at 1008.

Thus, using method 1000 the benefits of CIM module blocks 500 and 600 and accumulators 700 may be achieved. More specifically, improved flexibility and scalability may be attained.

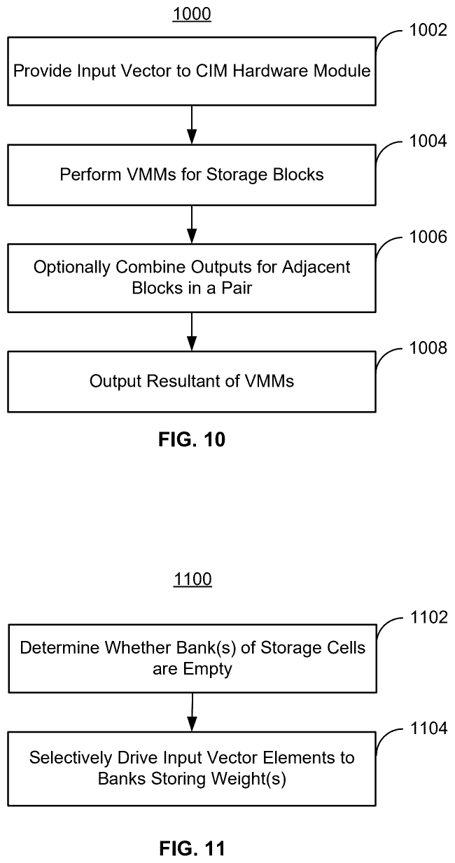

FIG. 11 is a flow-chart depicting an embodiment of method 1100 for managing driving of input vectors for a compute engine. Method 1100 is described in the context of compute engine 900. However, method 1100 is usable with other compute engines including but not limited to compute engine 900′, 100 and/or 200, compute tile 150, and/or other compute engines and/or compute tiles. Although particular processes are shown in an order, the processes may be performed in another order, including in parallel. Further, processes may have substeps.

At 1102 it is determined whether there are any empty banks of storage cells. For example, during writing of the weights, a bit may be set for a particular bank if the bank is written. At 1104, the input vector elements are selectively driven to the banks. Signals corresponding to the input vector elements are only driven to banks in which weight data is stored.

For example, at 1102 it may be determined that CIM module bank 1 910-1 and CIM module bank 3 910-3 do not store weight data. This may be determined when the weights are stored in compute engine 900. Also at 1102, some indication of this state may be provided, for example via signals select 1 and select 3. At 1104, select signals Select 1 and Select 3 deactivate the corresponding AND gates 940. In contrast. Select signals Select 0 and Select 2 allow the corresponding AND gates 940 to be activated. Thus, signals corresponding to the input vector elements are not driven to CIM module bank 1 910-1 and CIM module bank 3 910-3.

Method 1100 allows for power for compute engines may be better managed. Using method 110 logic gates 940 and/or 940′ may be selectively provided to drive signals for the input vectors through various banks 910. Consequently, banks 910 that do not store weights do not participate in VMMs. Thus, leakage power may be reduced. As a result, compute engine 900 may be more efficient.

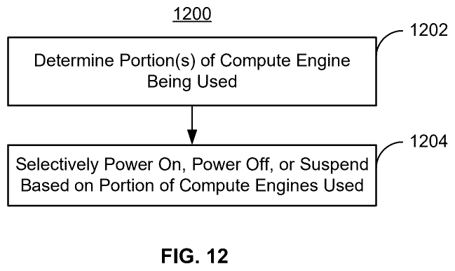

FIG. 12 is a flow-chart depicting an embodiment of method 1200 for managing power for a compute engine. Method 1200 is described in the context of compute engine 800. However, method 1800 is usable with other compute engines including but not limited to compute engine 100 and/or 200, compute tile 150, and/or other compute engines and/or compute tiles. Although particular processes are shown in an order, the processes may be performed in another order, including in parallel. Further, processes may have substeps.

At 1202 it is determined whether there are any portions of the compute engine that are not being used. For example, the compute logic may not be used when a weight update is being performed. At 1204, corresponding portions of the compute engine that are not being used may be powered off or suspended, while portions that are being used draw power.

For example, at 1202 it may be determined that the weights have been updated. If compute engine 800 is in a weight stationary architecture, weight update circuitry 820 may not be used for a long period of time. Thus, at 1204 update circuitry 820 is turned off (or put to sleep). In contrast, compute logic 810 and storage cells 830 may be powered on. For example, power units 842 and 846 may allow compute logic 810 and storage cells 830 to draw the appropriate power for operation (e.g. performing VMMs).

Method 1200 may improve power management for compute engine. Using step 1204, power units 842, 844, and/or 846, power may be selectively provided to compute logic 810, update circuitry 820, and/or storage cells 830. For example, regions 810, 820, and/or 830 may be completely powered on (ready to perform its operations), put in a low power and/or standby mode, or completely turned off. As a result, compute engine, such as compute engine 800, may be more efficient.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A compute engine, comprising:
an input buffer; and
a compute-in-memory (CIM) hardware module coupled with the input buffer, the input buffer being configured to provide an input vector to the CIM hardware module, the CIM hardware module including an array of storage cells for storing a plurality of weights corresponding to a matrix and compute logic configured to perform a vector-matrix multiplication (VMM) for the matrix and the input vector;
wherein the array of storage cells includes a plurality of storage blocks, each storage block including a portion of the array of storage cells corresponding to a plurality of rows and a particular number of columns corresponding to a portion of the matrix; and
the compute logic includes a plurality of compute logic blocks, each compute logic block corresponding to a storage block of the plurality of storage blocks, the compute logic block performing a portion of the VMM for the portion of the matrix.

2. The compute engine of claim 1, wherein each compute logic block includes an adder tree and an accumulator.

3. The compute engine of claim 2, wherein each storage block corresponds to a base precision of the plurality of weights.

4. The compute engine of claim 3, wherein the plurality of compute logic blocks includes compute logic block pairs and wherein the plurality of storage blocks includes storage block pairs, each of the compute logic block pairs includes a first compute logic block and a second compute logic block, wherein each of the storage block pairs includes a first storage block and a second storage block, the first compute logic block corresponding to the first storage block and the second compute logic block corresponding to the second storage block, each of the compute logic block pairs further including merge logic for merging a first resultant of the first compute logic block with a second resultant of the second compute logic block.

5. The compute engine of claim 4, wherein the base precision is four bits and wherein each of the plurality of weights is stored across the storage block pair.

6. The compute engine of claim 1, wherein the CIM hardware module includes a plurality of banks, each of the plurality of banks including at least one of the plurality of storage blocks; the CIM hardware module further including:
input vector driving circuitry for a first bank and a second bank of the plurality of banks, the input vector driving circuitry configured to drive the input vector to the second bank if the second bank stores a portion of the plurality of weights.

7. The compute engine of claim 1, further comprising:
weight update circuitry for storing data to the array of storage cells, wherein the compute logic, the array of storage cells, and the weight update circuitry are configured to be selectively receive power.

8. The compute engine of claim 7, wherein the compute logic, the array of storage cells, and the weight update circuitry are configured to be individually powered on, powered off, or placed in low power mode.

9. A compute tile, comprising:
at least one general-purpose (GP) processor; and
a plurality of compute engines coupled with the at least one GP processor, each of the plurality of compute engines including an input buffer and a compute-in-memory (CIM) hardware module coupled with the input buffer, the input buffer being configured to provide an input vector to the CIM hardware module, the CIM hardware module including an array of storage cells for storing a plurality of weights corresponding to a matrix and compute logic configured to perform a vector-matrix multiplication (VMM) for the matrix and the input vector;
wherein the array of storage cells includes a plurality of storage blocks, each storage block including a portion of the array of storage cells corresponding to a plurality of rows and a particular number of columns corresponding to a portion of the matrix; and
the compute logic includes a plurality of compute logic blocks, each compute logic block corresponding to a storage block of the plurality of storage blocks, the compute logic block performing a portion of the VMM for the portion of the matrix.

10. The compute tile of claim 9, wherein each compute logic block includes an adder tree and an accumulator.

11. The compute tile of claim 10, wherein each storage block corresponds to a base precision of the plurality of weights.

12. The compute tile of claim 11, wherein the plurality of compute logic blocks includes compute logic block pairs and wherein the plurality of storage blocks includes storage block pairs, each of the compute logic block pairs includes a first compute logic block and a second compute logic block, wherein each of the storage block pairs includes a first storage block and a second storage block, the first compute logic block corresponding to the first storage block and the second compute logic block corresponding to the second storage block, each of the compute logic block pairs further including merge logic for merging a first resultant of the first compute logic block with a second resultant of the second compute logic block.

13. The compute tile of claim 12, wherein the base precision is four bits and wherein each of the plurality of weights is stored across the storage block pair.

14. The compute tile of claim 9, wherein the CIM hardware module includes a plurality of banks, each of the plurality of banks including at least one of the plurality of storage blocks; the CIM hardware module further including:
input vector driving circuitry for a first bank and a second bank of the plurality of banks, the input vector driving circuitry configured to drive the input vector to the second bank if the second bank stores a portion of the plurality of weights.

15. The compute tile of claim 9, further comprising:
weight update circuitry for storing data to the array of storage cells, wherein the compute logic, the array of storage cells, and the weight update circuitry are configured to be selectively receive power.

16. The compute tile of claim 15, wherein the compute logic, the array of storage cells, and the weight update circuitry are configured to be individually powered on, powered off, or placed in low power mode.

17. A method, comprising:
providing an input vector to a compute-in-memory (CIM) hardware module, the CIM hardware module including an array of storage cells for storing a plurality of weights corresponding to a matrix and compute logic configured to perform a vector-matrix multiplication (VMM) for the matrix and the input vector, the array of storage cells including a plurality of storage blocks, each storage block including a portion of the array of storage cells corresponding to a plurality of rows and a particular number of columns corresponding to a portion of the matrix, the compute logic including a plurality of compute logic blocks, each compute logic block corresponding to a storage block of the plurality of storage blocks; and
performing, using the CIM hardware module, the VMM such that each compute logic block performs a portion of the VMM for the portion of the matrix.

18. The method of claim 17, wherein the plurality of compute logic blocks includes compute logic block pairs and wherein the plurality of storage blocks includes storage block pairs, each of the compute logic block pairs includes a first compute logic block and a second compute logic block, wherein each of the storage block pairs includes a first storage block and a second storage block, the first compute logic block corresponding to the first storage block and the second compute logic block corresponding to the second storage block, each of the compute logic block pairs further including merge logic for merging a first resultant of the first compute logic block with a second resultant of the second compute logic block, each of the plurality of storage blocks corresponding to a base precision, and each of the plurality of weights being stored in a pair of storage cells corresponding to a compute logic block pair, wherein the performing the VMM further includes:
determining the first resultant and the second resultant; and
merging, using the merge logic, the first resultant and the second resultant to provide a final resultant for the VMM.

19. The method of claim 17, wherein the CIM hardware module includes a plurality of banks, each of the plurality of banks including at least one of the plurality of storage blocks, the plurality of banks including a first bank and a second bank, the method further including:
selectively driving the input vector to the second bank of the first bank and the second bank if the second bank stores a portion of the plurality of weights.

20. The method of claim 17, wherein the CIM hardware module further includes weight update circuitry for storing data to the array of storage cells, wherein the compute logic, the array of storage cells, and the weight update circuitry are configured to selectively receive power and wherein the method further includes:
individually powering on, powering off, or placing in low power mode the weight update circuitry the array of storage cells, and the compute logic.
